(19) United States
(12) Patent Application Publication
(10) Pub. No.: US 2016/0078541 A1
(43) Pub. Date: Mar. 17, 2016

(54) SYSTEMS AND METHODS FOR CONSTRAINED RESOURCE SOLUTION OPTIMIZATION

(71) Applicant: Retirement Navigator Inc., Toronto (CA)

(72) Inventors: John H. Wall, Sparks, MD (US); Craig Kenneth McConomy, Toronto (CA); Marius Dan Stroe, Ajax (CA)

(21) Appl. No.: 14/851,881

(22) Filed: Sep. 11, 2015

Related U.S. Application Data
(60) Provisional application No. 62/049,532, filed on Sep. 12, 2014.

(51) Int. Cl. G06Q 40/06

(52) U.S. Cl. CPC G06Q 40/06

(57) ABSTRACT

There is provided a system and method for constructing, scoring and determining optimal cash flow solutions for use of funds, such as in retirement. Such systems and methods include apportioning strategies for constructing the set of possible solutions, scoring methods to reflect an optimal solution, and heuristics and metaheuristics for maximizing computational resources to arrive at an optimal cash flow solution.

### FIELD OF THE INVENTION

The present invention relates generally to systems and methods for creating a solvable resource optimization problem and finding an optimal or best solution to such problem. The present invention relates more particularly to systems and methods to construct cash flow solutions where infinite solution possibilities may exist, and solution desirability may be at least somewhat subjective.

### BACKGROUND OF THE INVENTION

A great deal of time and expertise has been developed to assess how much money a person, such as a retiree or person nearing retirement, must amass in order to not run out of money during their life. Various approaches have been taken, including rules of thumb and detailed predictions of expenses in retirement. In general, most planning systems rely on focusing on a few objectives to determine an optimistic outcome. Some are as simple as building up enough wealth to support 60 percent of your pre-retirement income for your post-retirement years. Others are more sophisticated, but generally break up the wealth building process and the wealth draw down process. In reality these are not independent and people often combine them or switch between them as they age (for example having a windfall, property sale, salary increase, have a spouse retiring, etc). A typical example may be Naviplan™, or approaches as described in books like “Your Retirement Income Blueprint” by Darly Diamond.

What has been severely lacking is a comprehensive and systematic approach to effectively using the amassed funds to pay ongoing expenses of life/retirement in the best possible way using the revenue streams and assets amassed, all while recognizing that assets may still be accumulating and/or reorganized during this time. This shortfall in retirement planning is largely due to: the complexities of creating a mechanism to configure the parameters involved so that a solution can be obtained (including income splitting, tax implications, defined pension plans, tax free vehicles, and the like), an approach to creating one solution, an approach to varying that solution to find a preferable (or even most preferable) solution, and the computational challenges associated with near infinite combinations of uses of various revenue streams and assets to pay ongoing life expenses.

Essentially this “retirement cash flow problem” can be an NP complete problem—where any solution to an NP-complete problem can be verified quickly (in polynomial time), but there is no known efficient way to locate a solution in the first place.

Despite these challenges, there still remains an important need for people to understand how best to use their money in their retirement, with an ability to compute a good solution without using infinite computational effort.

There thus remains a need for systems and methods to determine an optimal cash flow solution to pay on-going expenses in retirement.

### SUMMARY OF THE INVENTION

There is a method for selecting, computing and scoring optimal or best cash flow solutions for a user having an estimated lifespan, the user having a set of money streams comprising fixed money streams, savings streams and asset depletion money streams, and a set of money sinks that vary each year for the user's life, cash flow solutions including how much money is to be used from each money stream for each year to attempt to meet the total money sinks for each year in a best or optimal way, the method comprising: obtaining, for the user, the money sources and money sinks for each year of the user's lifespan; setting one or more configuration parameters; determining a set of possible cash flow solutions based on the configuration parameters; and until an end trigger is received: selecting from the set of possible cash flow solutions, a possible cash flow solution; scoring the possible cash flow solution to determine a score; if the possible cash flow solution has a score that is better than a best score then: saving the possible cash flow solution as the best cash flow solution, with the score as the best score.

The configuration parameters may comprise an apportionment strategy.

The apportionment strategy may be assigning each money stream a percentage of the money sink for each year of the lifespan.

The configuration parameters may further comprise a percentage increment such that in assigning each money stream a percentage the percentage is incremented or decremented by the percentage increment in the determining.

The configuration parameters may comprise one or more heuristics or metaheuristics and a computing time, wherein the max computing time is an end trigger.

The selecting may be based on the one or more heuristics or metaheuristics.

The configuration parameters may comprise one or more hard constraints and one or more soft constraints.

The scoring may further comprise: specifying whether the best cash flow solution may break any of the one or more hard constraints.

The scoring may further comprise: for each year of the lifespan: querying whether a difference between a sum of the revenue streams for the year and the sum of the revenue sinks for the year is within a tolerable range; and if so then assigning a yearly score of zero for the year, otherwise setting the yearly score for the year to be the difference between the sum of the revenue streams for the year minus the sum of the revenue sinks for the year; and summing each yearly score to determine the score.

The scoring may further comprise determining one or more soft scores for the cash flow solution and if the score and the best score are similar then comparing one or more soft scores to determine whether the score is the best score.

The obtaining may further comprise one or more characteristics of the money sources.

The characteristics of the money sources may comprise an expected rate of return, for each year of the lifespan.

There is also a system for selecting, computing and scoring optimal or best cash flow solutions for a user having an estimated lifespan, the user having a set of money streams comprising fixed money streams, savings streams and asset depletion money streams, and a set of money sinks that vary each year for the user's life, cash flow solutions including how much money is to be used from each money stream for each year to attempt to meet the total money sinks for each year in a best or optimal way, the system comprising: a web application configured to: obtain, for the user, the money sources and money sinks for each year of the user's lifespan; a configuration engine configured to: set one or more configuration parameters; a combination generator, configured to: determine a set of possible cash flow solutions based on the configuration parameters; and a scoring engine configured to: until an end trigger is received: selecting from the set of possible cash flow solutions, a possible cash flow solution; scoring the possible cash flow solution to determine a score; if the possible cash flow solution has a score that is better than a best score then: saving the possible cash flow solution as the best cash flow solution, with the score as the best score.

The configuration parameters may comprise an apportionment strategy.

The apportionment strategy may be assigning each money stream a percentage of the money sink for each year of the lifespan.

The configuration parameters may further comprise a percentage increment such that in assigning each money stream a percentage the percentage is incremented or decremented by the percentage increment in the determining.

The configuration parameters may comprise one or more heuristics or metaheuristics and a computing time, wherein the max computing time is an end trigger.

The selecting may be based on the one or more heuristics or metaheuristics.

The configuration parameters may comprise one or more hard constraints and one or more soft constraints.

The scoring may further comprise: specifying whether the best cash flow solution may break any of the one or more hard constraints.

The scoring may further comprise: for each year of the lifespan: querying whether a difference between a sum of the revenue streams for the year and the sum of the revenue sinks for the year is within a tolerable range; and if so then assigning a yearly score of zero for the year, otherwise setting the yearly score for the year to be the difference between the sum of the revenue streams for the year minus the sum of the revenue sinks for the year; and summing each yearly score to determine the score.

The scoring may further comprise determining one or more soft scores for the cash flow solution and if the score and the best score are similar then comparing one or more soft scores to determine whether the score is the best score.

The obtaining may further comprise one or more characteristics of the money sources.

The characteristics of the money sources may comprise an expected rate of return, for each year of the lifespan.

### BRIEF DESCRIPTION OF THE DRAWINGS

Embodiments will now be described, by way of example only, with reference to the attached Figures, wherein:

FIG. 1 shows a system for determining a cash flow solution according to an embodiment of the invention;

FIG. 2 shows a method for determining a cash flow solution according to an embodiment of the invention;

FIGS. 3-14 show screens for a method for determining a cash flow solution according to an embodiment of the invention;

FIG. 15 is an XML file of various inputs and configurations for determining a cash flow solution according to an embodiment of the invention; and

FIGS. 16-18 show exemplary data representing a partial cash flow solution for a given input.

### DETAILED DESCRIPTION OF THE EMBODIMENTS

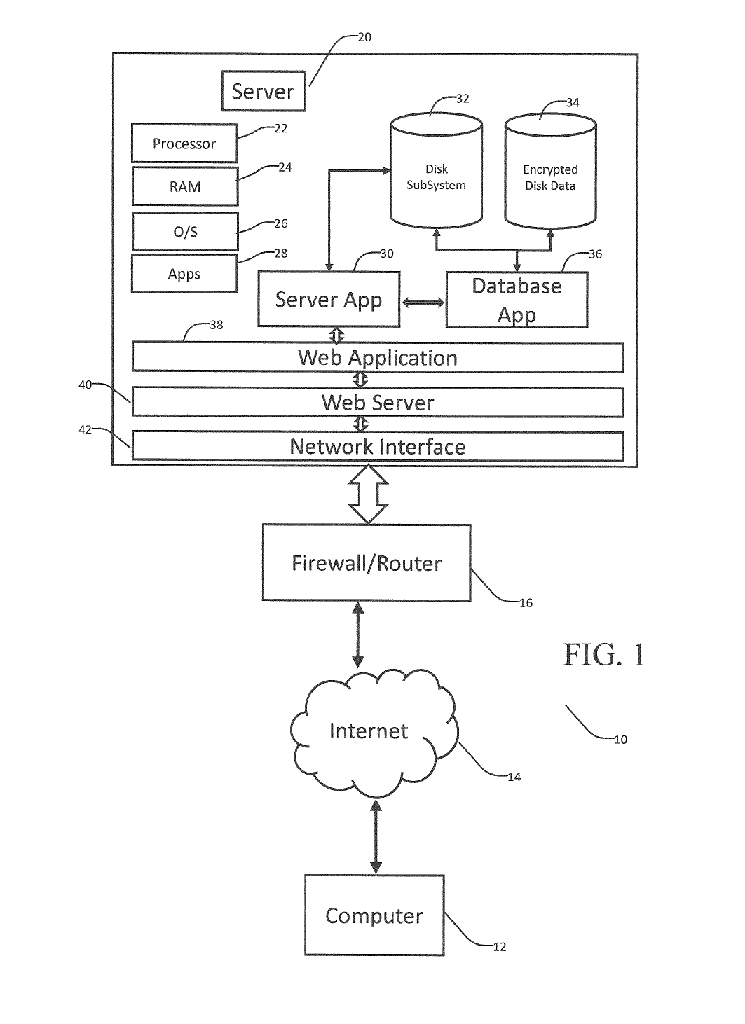

FIG. 1 shows a system 10 for determining a cash flow solution according to an embodiment of the invention comprising computing device 12, communication network 14, firewall 16, and server 20 further comprising processor 22, RAM 24, operating system 26, applications 28, server application 30, database application 36, disk subsystem 32, encrypted disk subsystem 34, web application 38, web server 40 and network interface 42.

A user desiring to interact with server 20 may use computing device, which may be substantially any network connected device such as a PC, tablet, smart phone, wearable device, and the like. Computing device may communicate over communication network 14 (which may be the Internet or some other form of network as known in the art) and access server 20 via a firewall or router 16.

Server 20, via one or more of the components therein, may provide the functionality described herein, including the methods described herein, in conjunction with or independently from other components of system 10. Of course it is to be understood that many hardware components and combinations are possible. Generally server 20 may be high performance machines, and may in fact be multiple high performance machines working together such that the methods and problems solved may run across multiple computers and broken up into pieces of processing. The sheer number of computations may require such a capable hardware platform.

Server app 30, or other components of server 20, may further comprise configuration engine, combination generator (not shown but as described herein and generally taking the inputs and configurations and determining the universe of solutions) and scoring engine (not shown but as described herein and generally receiving a solution and returning the solution's score based on the configurations provided).

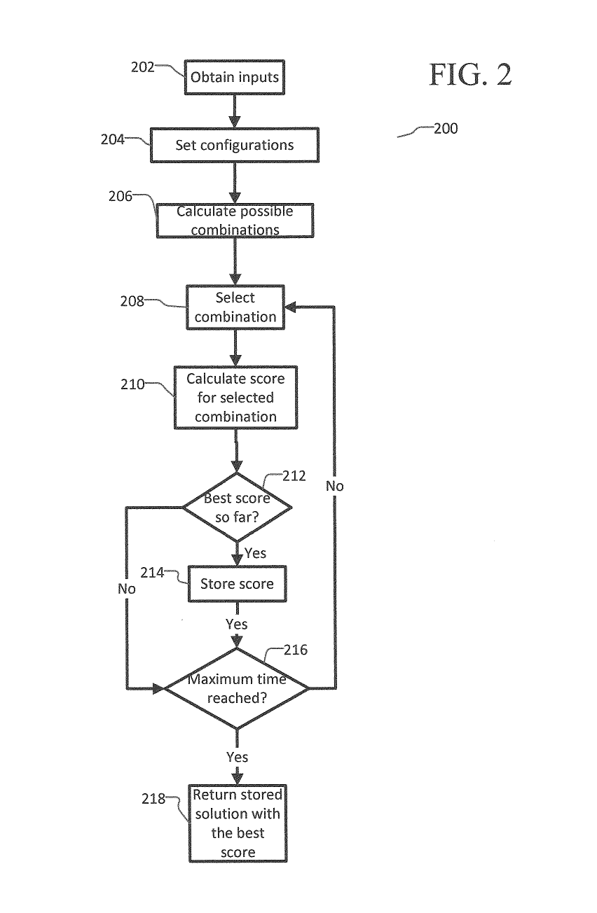

FIG. 2 shows a method 200 for determining a cash flow solution according to an embodiment of the invention. Various parts of method 200 may be done by various parts of system 10 and server 20. For example, computer 12 may allow retiree to provide inputs, configuration engine may allow configuration and/or assist in storing or retrieving configurations, combination generator may perform 206, scoring engine may perform 210, and so on.

A few of the terms used herein are below described:
Retiree: is the person for whom the cash flow solution is being determined. Although the term being used herein is retiree this invention, and cash flow solutions, apply to substantially anyone, even if they are not retired or even soon-to-be retired. Terms used herein may include “user”, “investor” and the like.
Solution type: each solution may be described as one or more of the following “solution types”:
   Possible solution: is essentially any solution from the possible combinations. This could be a worthless solution, like where you run out of money before you die.
   Feasible/viable solution: this is a solution that does not break any hard constraints but also meets the objective of being viable. All feasible solutions are possible solutions.
   Best solution: the highest scoring solution found over a given amount of time or before another “end trigger” is reached (such as an amount of time, a number of solutions attempted, a satisfactory score is reached). The best solution is likely to be feasible and given enough time in analysis also optimal, though it should be noted that a “best solution” may be the solution found that least violates a hard constraint, for example (as even where there is no feasible solution a best solution may still be desirable to present).
   Optimal solution: This is a solution with the highest possible score. In the problem space of retirement or financial planning there can often be more than one optimal solution, especially depending on the granularity of the configurations and the scoring algorithm, but there is at least one.
Inputs: any information provided to system 10 in advance of determining a solution. Inputs may be separate from configurations, and may refer to the specific information relating the retiree, as opposed to configuring of system 10 (including how to determine combinations, score solutions, and the like). Inputs may include money sources and money sinks
Fixed money streams: government programs, pensions, RIF and the like—substantially any revenue stream that either does not change or that the retiree cannot generally change in a given year. Fixed money streams are typically treated as constants in a given year and not varied to determine solutions.
Savings streams: streams that reduce, or reflect deductions to savings assets (such as investment accounts, TFSAs, and the like). Importantly savings streams, and various other inputs, may have expected and/or experienced rates of return, such that cash flow solutions can seek to allow high-return savings streams to continue to grow without withdrawing from them (and withdrawing instead from low-return savings streams). Savings streams (or any particular stream for that matter) may be classified as taxable or not, which may allow calculations to be done to determine the after-tax impact (expense or revenue) of the stream.
Asset depletion money streams and capital: these occur from the sale of an asset that typically has lower liquidity than savings streams, such as properties (houses, cottages, etc), automobiles, art, and the like. Selling or otherwise encumbering these assets can produce a one-time windfall that may be then used to provide streams of revenue. Asset depletion capital may be converted into one or more savings streams (such as depositing the profits from a house sale into a TFSA and/or RRSP). For simplicity of description asset depletion revenue streams, or revenue streams resulting from asset depletion capital, may be treated as savings streams but may be treated as less favorable than other savings streams.
Retiree Information: Their age, citizenship, number of kids/dependents, armed forces status, retirement year goal (or when the financial plan is to occur or cover), their life expectancy or lifespan (which may be calculated as known in the art of insurance or other actuarial sciences).
Configurations: configurations are generally settings that are required to determine a solution. Configurations may fall into two categories—solution configurations and environment configurations.
   Environment configurations: these relate to configurations for the environment the retiree is in. This may include jurisdiction configurations such as tax rates, income splitting policies, RIF draw-down rates/percentages, government revenue sources or revenue sinks, and the like. Environment configurations typically vary largely based on the jurisdiction(s) that apply to the retiree, as opposed to how a solution is processed.
   Solution configurations: these relate to how the system is set up in order to determine cash flow solutions. Solution configurations may include establishing hard constraints and soft constraints, apportionment strategies, max computation time, heuristics and metaheuristics to be used, and the like, as further described herein.

Before describing method 200, it may be useful to provide some insight into a “simple” NP problem that could be created following the approaches herein, which highlights some of the aspects of the invention that address the inability of humans to practice the invention without the sophisticated hardware and algorithms herein:

In a simple scenario practicing aspects of the invention, there could be: 4 Variable Funds (revenue streams), 5% increments per year (ie the MSAP/RSAP), 20 Years of retirement or financial planning. The 1 year problem space would be 20′4 combinations to choose from (160,000). The 20 year plan, would include 20̂(20*4) combinations of plan possibilities (1.20892581961463E104—a huge number). By using method 200 in various embodiments (for example different heuristics and meta-heuristics and combinations thereof) the problem space can be narrowed down and optimal solutions located.

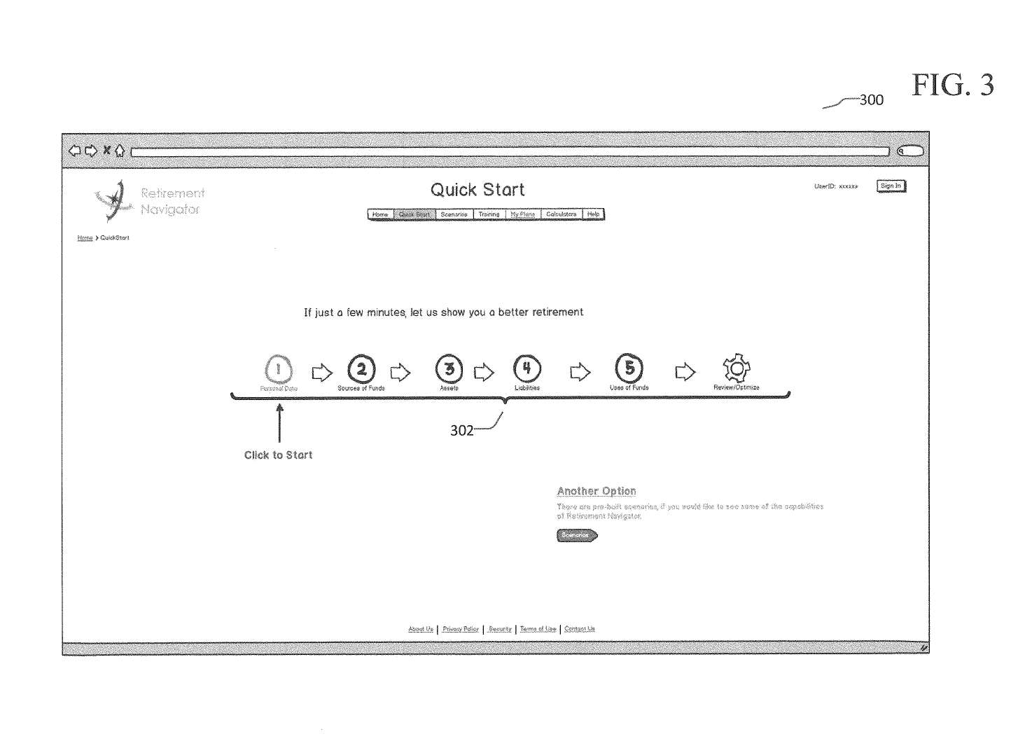

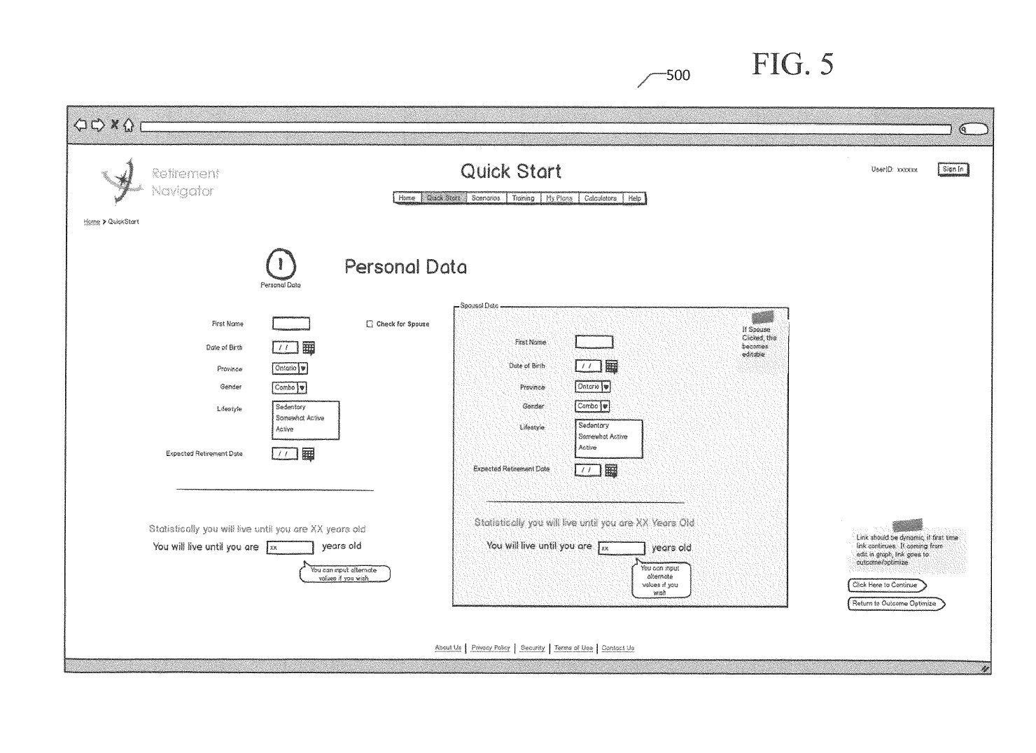

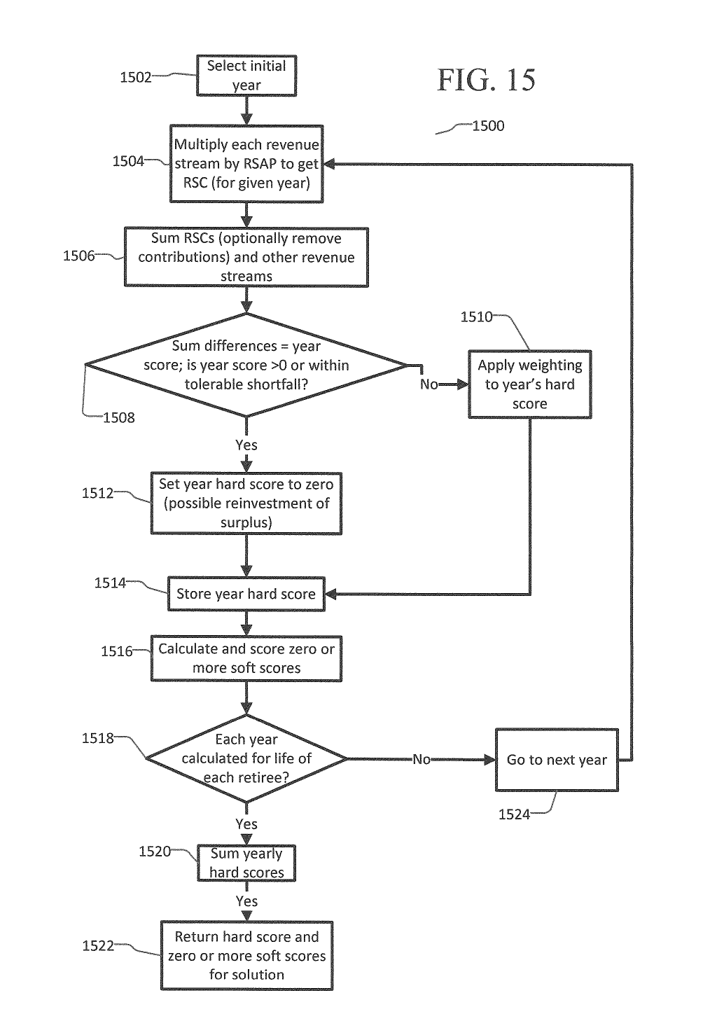

Method 200 begins at 202 where the inputs are obtained. This may be done, for example, via one or more screens as shown in FIGS. 3-14 and more particularly FIGS. 5-8. Alternative methods are of course possible, including voice commands, electronic files, financial planning software, and the like (such as XML file as shown in FIG. 15, which may be created or obtained via various methods). As described herein, the inputs obtained relate to the financial details of the user or retiree being considered.

Method 200 then continues at 204 to set configurations.

As described above, configurations comprise both solution and environment configurations. Setting configurations at 204 may include both.

Setting environment configurations may largely be jurisdiction-based. Each jurisdiction may have a configuration file that can be loaded and used. Such configuration file may be prepared and maintained by an investment advisor that keeps current on rules, regulations, laws, and data for a particular jurisdiction. Although various parts are described further herein, the actual creation of these configurations is largely based on the jurisdiction and available approaches therein.

Setting solution configurations relates more to how to arrive at cash flow solutions. A few solution configurations are now considered.

Apportionment strategies: Where the overall cash flow requirements are to be met by a set of revenue streams, including a set of savings streams, how do you apportion coverage of cash flow requirements (from the total money sinks) to money sources (such as savings streams). As the number of variables gets large the issue becomes significant and difficult. While many apportionment strategies are possible, a novel approach was considered whereby each savings/money stream is assigned a percentage of the cash flow requirement for a given year (or a percentage of the cash flow requirement for a given year after money from fixed revenue streams were accounted for). These percentages are referred to herein as money/revenue streams apportionment percentages (MSAP/RSAP). The sum of the MSAP/RSAP were therefore always 100% (subject to accounting for fixed money streams). RSAP can also have a percentage increment amount associated therewith, such that when solutions are being computed the RSAP are changed by the percentage increment amount. In a situation where a quick solution is desired, possibly with little computing power, the percentage increment amount may be set at 10% or even 25%.

In essence, this apportionment strategy provides a way of translating a financial plan input (or generally a set of inputs) into a list of possible solutions. Each solution is a combination of what percentage of the available variable funds or revenue streams are used in satisfying the total use of cash flow for each particular year in the plan. In addition, each spouse can contribute more or less to the cash flow each year. All these combinations make the possible solution space very big, but it makes a score calculator able to function in the financial planning world and it makes translating the optimal/best solution into a feasible financial plan. The scoring engine and approaches to calculating a score for a solution make it possible for system 10 to differentiate between possible solutions and therefore find a “best solution”. Any type of solution is a financial plan because it describes how to use the funds to satisfy the cash flow.

Hard constraints: Hard constraints are constraints that cannot be broken for a solution to be feasible. Hard constraints may include “use a particular revenue stream first”, “a retiree may only have one primary residence for tax purposes”, “make sure the cash flow requirements are met every year” (possibly within a certain tolerance), and the like. Having money in the user's last year may also be a hard constraint, though there may not be any feasible solutions if this is added as a hard constraint (as some people simply will run out of money for the money sinks they desire at some point in their life). Hard constraints (and soft constraints for that matter) can be both positive (“do this”) and negative (“don't do this”).

Soft constraints: Soft constraints are constraints that may be broken (ie breaking them does not preclude a feasible solution) but may not be desirable. Examples may include “minimize tax payments”, “stay in current house as long as possible”, “use income splitting if possible”, “maximize funds at death” (which may be hard or soft), and the like. Soft constraints may form part of calculating optimal solutions (in that solutions that break fewer soft constraints may be scored more highly (as described herein).

Heuristics/Metaheuristics: along with apportionment, determining one or more heuristics/metaheuristics to use to determine a) solutions and b) optimal/best solutions is complicated. All analysis to achieve an outcome (regardless of possible outcomes analyzed) involves a combination of heuristic and metaheuristic analysis. The solution may include the following configuration models to support evaluation the solution space to solve to an optimized retirement:
Heuristic: First Fit, Best Fit, Cheapest Insertion
Meta Heuristic: Tabu Search, Simulated Annealing, Late Acceptance, Genetic Algorithms

In metaheuristics one part of the problem is defining a list of all the possibilities. When solving an NP complete problem, an algorithm must start with a list of possible solutions. This list is usually extremely large. Each solution in the list can be evaluated by calculating a score specific to that solution. A score consists of hard constraints and soft constraints as defined above. Based on the metaheuristic model chosen, only some of the solutions may be evaluated based on the score calculation method built specifically in the financial planner and engine. Metaheuristics algorithms will try to choose the next potential solution based on previous evaluated solutions and a sophisticated set of rules that try to pick solutions that have the highest probability of increasing the score.

Max Computation Time: the amount of time that you are willing to let the computing continue.

Method 200 then continues at 206 to calculate or determine all possible combinations (ie the set of possible solutions, regardless of whether they are feasible, etc). This is based on the inputs (in particular it may be based on the variable revenue streams) and the yearly cash flow requirements (revenue sinks), and the apportionment strategy employed. This provides the entire solution set from which solutions/combinations can be selected (based on heuristics and metaheuristics) for scoring.

Then at 208 a combination is selected to start. This selection may be made using any number of heuristics or metaheuristics.

At 210 the selected combination will be scored.

Scoring may be determined in many ways. Scores for a given year and given solution may be made up of hard scores and soft scores. Hard scores are based on hard constraints while soft scores are based on soft constraints. Generally, scores for a solution may be made up of hard scores for each year, summed together, optionally via a weighted sum (as described herein) and zero or more soft scores for each year, summed together, optionally via a weighted sum (as described herein). Scores may be calculated according to method 1500 of FIG. 15, as described herein.

At 212 if the calculated score for the currently considered solution is the best score then method 200 continues at 214 to store the score (and solution) as the best current solution. Otherwise, or after storing at 214, method 200 continues at 216 to query whether the maximum computational time has been reached. If so method 200 returns the solution/combination (with scores and optionally all data related to the solution) as the solution to use/suggest. Otherwise method 200 returns to 208 to select another combination to consider.

Instead of reaching a maximum time, other methods of stopping computation in method 200 are possible. For example, computation may stop if the score does not improve after a number of solutions are evaluated. A combination of time and lack of improvement is also possible. For example, try method 1 for 1 min or stop if the solution did not improve after 50 steps. Move to method 2 in a similar manner. Other approaches are of course possible based on computing, client, or solution preferences.

It should be noted, in returning to 208, that the next combination for consideration will depend on the heuristics and metaheuristics chosen in configuring. For example, one or more RSAPs (optionally even just one) may be modified (using the heuristics and/or metaheuristics) to try to pursue a local (or global) maximum in the solution set (representing an optimal or best solution possibly). If the current solution is identified as a possible/probable local maximum then a new “seed” solution may be selected (again using one or more of heuristics and/or metaheuristics).

In one embodiment, 208-216 may be run multiple times with different heuristic/metaheuristic methods during one iteration (ie in searching for one best solution). The maximum time may then be composed of multiple maximum times for each heuristic method. An overall max time could also be provided. For example, first try method 1 (ie a particular combination of heuristics and/or metaheuristics, or particular starting point) for 1 min, then method 2 for 2 min. Then the best single solution from the two runs may be selected.

Returning to 210, a solution is scored according to method 1500 in FIG. 15.

Method 1500 provides one approach to scoring a solution. Generally method 1500 calculates, for each year of the solution, how many dollars short a retiree may be in a given year (ie how many more revenue stream dollars do they need to cover all revenue sink dollars, or the total cash flow requirements for the year). In one embodiment of method 1500 the hard constraint is having enough money each year (subject to the caveats described herein) so that the hard score represents the extent to which such hard constraint is not achieved. The score is thus a negative number, but the closer to zero the better.

Method 1500 begins at 1502 where the initial year is selected. This is likely simply the current year (or one year ahead) but may be any year.

At 1504 then each revenue stream in the solution is multiplied with its RSAP to get revenue stream contributions (RSCs) for the given year.

At 1506 the RSCs are summed, along with other revenue streams. It is worth noting at this stage that when summing RSCs the scoring engine may take into account contributions that may be made to assets or revenue streams (for example making contributions to TFSAs that tend to have extra benefit in the long-run and are thus worth contributing to even during the solution's years). Taking this into account may be done automatically by the engine, or may be an input that can be set by a user.

Continuing along at 1508 a query is made whether the difference between the sum of the revenue streams minus the sum of the revenue sinks (for the particular year—which may be the year's hard score) is zero or within a tolerable range (in one embodiment all deviations, whether surpluses or shortfalls, are treated as negative amounts to be summed). For example, a variance of a few hundred dollars, or a small percentage of the revenue sinks, may be considered acceptable, and so the difference for that year may be set to zero (where the acceptable range may be defined in configurations or inputs, for example). Although a punitive score may be applied in the event that too much income is redeemed in a year (for example, in the event of a real estate sale), the system may attempt to take any surplus and invest it in existing investment funds. Thus in practice there may never be spare or surplus money at the end of the year to penalize (though penalties may be applied to shortfalls, as described herein).

If so then method 1500 continues to 1512 where the year's hard score may be set to zero. A year's score, if the result of a surplus, need not be set to zero, but it may be so that a positive year does not make an overall solution more or less desirable than it ought (as a primary goal for a retiree may be to have enough money each year, as opposed to having a few years where they have significant excess but are otherwise lacking in some years).

If the answer is no at 1508 then method 1500 continues at 1510 where a weighting may be applied to a year's score (a yearly score). Weightings can relate to many factors, but may generally used to increase the negative impact of a poor score (ie to embellish a shortfall of cash). For example, a shortfall early in a solution (ie 20 years before death) may be worse than a shortfall late in a solution (ie 2 years before death) so a weighting may be applied to the early shortfall. One such weighting is:

−thisYearsPenalty*=Math·pow(earlyPenaltylnflation, lastYear−yearlyPlan·getYear( )+1);

which means (assuming an ‘early penalty’ of 20% and that the solution is for 2014-2040)

thisYearsPenalty=thisYearsPenalty*(1.2)(to the power of 2040-2014)

ThisYearsPenalty would then be multiplied by the absolute value of the negative number of the yearly score, and the resultant yearly score would be a larger negative number.

At 1514 (from 1510 or 1512) the year's hard score is stored.

Then at 1516 zero or more soft scores may be calculated and stored for the solution. Soft scores may be set in configurations, for example. There may be any number of calculations or soft scores. Soft scores may be used to break ties (or near ties) in hard scores (or used in conjunction with hard scores). Soft scores may indicate “nice to have” aspects of a solution.

A few examples of soft scores may include:
Minimize Taxes: The total amount of tax paid (between the retiree and/or their spouse) is included as a negative number (optionally weighted). Yearly amounts are determined, and summed for the solution's soft score.
Maximize Income Splitting: This may be somewhat akin to minimizing taxes, but considers how much income splitting is occurring. A yearly positive amount may be deducted, such that larger scores are preferable.
Other soft scores may be created based on perceived or predicted benefits in the future (such as amended legislation, risk of pensions being underfunded and thus not providing revenues, and the like).
Minimize OAS clawback: reduce the money that the government takes back from OAS (old age security security) when income is higher than a certain amount.

At 1518 if each year of the solution is not calculated then at 1524 method 1500 goes to the next year and continues at 1504. Otherwise at 1520 the yearly hard scores (and zero or more soft scores) are summed. Then at 1522 the hard score, and zero or more soft scores are returned to method 200.

In another embodiment of method 200, a financial planner may determine or create a baseline solution that may later be incorporated into method 200—for example as; a first selected combination at 208, one seed combination at 208, a best score to compare to, or another manner. In this type of embodiment a financial planner may follow industry best-practices to attempt to minimize taxation on a year by year basis, and from the earliest to the latest year (and withdrawing first from non-registered funds and then from the lowest interest funds). This is an example of a typical but fairly rudimentary or crude approach that is used, out of necessity, without the present invention. The crude nature—which is largely that once the framework is applied, even a seasoned financial advisor will be making small changes to that pre-determined drawdown strategy—makes it quite possible to tweak a traditional strategy to reach a local optima on minimizing taxes, without realizing that a radically different but non-traditional approach might preserve assets better.

Method 200 may then commences, and operates essentially “blindly”, without a pre-determined disbursement plan. Instead it rapidly evaluates different drawdown strategies distributed throughout the possible combination space, looking for trends in improved scoring—all as described herein. The addition of the baseline means that instead of starting with no solution, there is a baseline (which can be calculated quickly due to its simplicity) and score the baseline as a starting solution and then the regular planning strategy may be run or used, trying to improve on the initial baseline solution. In the worst case, if the systems and methods herein cannot improve on the baseline, the baseline may be the final and best solution.

In one example system 10 was provide a base solution that resulted in the below yearly deltas (ie differences between the sum of the revenues and sum of the expenses) (see Table 1, “Base” rows). The system then ran method 200 to arrive at the “Engine” Yearly Deltas (noting that these may all be treated as negative values but are shown as positives. The result is that the sum of the deltas for the baseline was $298817 and the sum of the yearly deltas for the optimized approach was $235193. This means that over 18 years a retiree would be over $60,000 further ahead using the “Engine” solution.

TABLE 1
Baseline solution and Engine solution “Yearly Deltas”

| Yr | 1 | 2 | 3 | 4 | 5 | 6 | 7 | 8 | 9 | 10 | 11 |
|---|---|---|---|---|---|---|---|---|---|---|---|
| Engine | $1 | $1 | $2 | $3 | $3 | $2 | $3 | $3 | $4 | $6 | $2 |
| Base | $1 | $1 | $2 | $3 | $3 | $2 | $3 | $3 | $4 | $5 | $3 |

| Yr | 12 | 13 | 14 | 15 | 16 | 17 | 18 |
|---|---|---|---|---|---|---|---|
| Engine | $2,267 | $3 | $4 | $3 | $3 | $84,357 | $148,526 |
| Base | $3 | $41,252 | $3 | $2 | $3 | $110,046 | $147,478 |

FIGS. 3-14 show screens for a method for determining a cash flow solution according to an embodiment of the invention. Retirees, via one or more screens such as are shown in FIGS. 3-14, may provide inputs, configurations and other details to determine one or more optimal plans and then review, amend and save such one or more plans. These screens may be implemented by one or more of the components of system 10—for example with retirees accessing screens via computing device 12, and functionality being carried out on other parts of system 10.

FIG. 3, in screen 300, provides an overview of the various portions of producing and reviewing solutions, as demonstrated in solution chronology overview 302. In general, personal data may be collected, sources of funds determined, assets listed, liabilities detailed, and desired uses of funds (revenue sinks) set out. Reviewing/optimizing may then allow solutions to be viewed, amended and saved. Of course the data entered may be real or may be scenario based, and there may be sample inputs and solutions, such as for demonstration purposes.

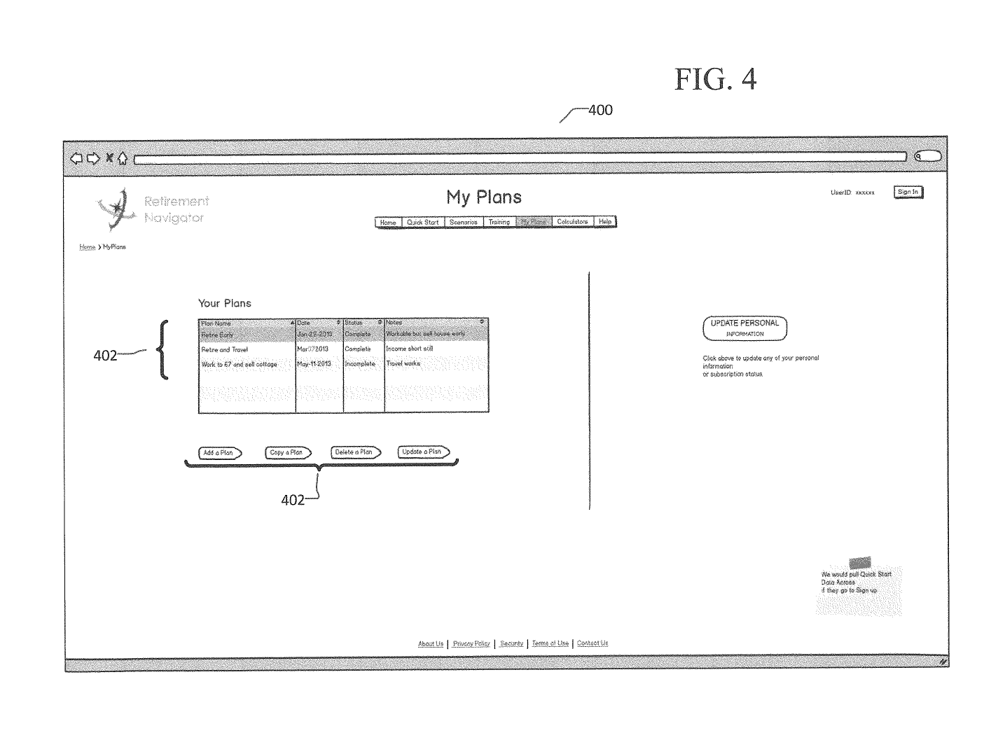

FIG. 4, in screen 400, provides multi-plan table 402 where a particular retiree's one or more plans and solutions may be interacted with (such as via buttons 402 that allow a plan to be added, copied, deleted and updated). Table 402 reflects that system 10 may store one or more desired/desirable plans for a retiree where the retiree wants to test various “life plans”—such as retiring early, selling a home sooner, buying a cottage, switching jobs, and the like. These major life events can cause quite a change in a retiree's financial future; such major changes can be easily digested and understood by setting up several “life plans” in the form of inputs resulting in solutions.

FIG. 5, in screen 500, allows retirees to enter personal data, as described herein. It may also allow entering some configuration data (though some configuration data may be determined not by retirees but by ‘super users’ or administrators depending on someone's access level and comfort with the concepts herein, or may be set in configuration files). In screen 500 a user can use the statistical age at which they will die or may input an alternative, for example to account for being conservative or aggressive (and desiring to see the impacts such would have).

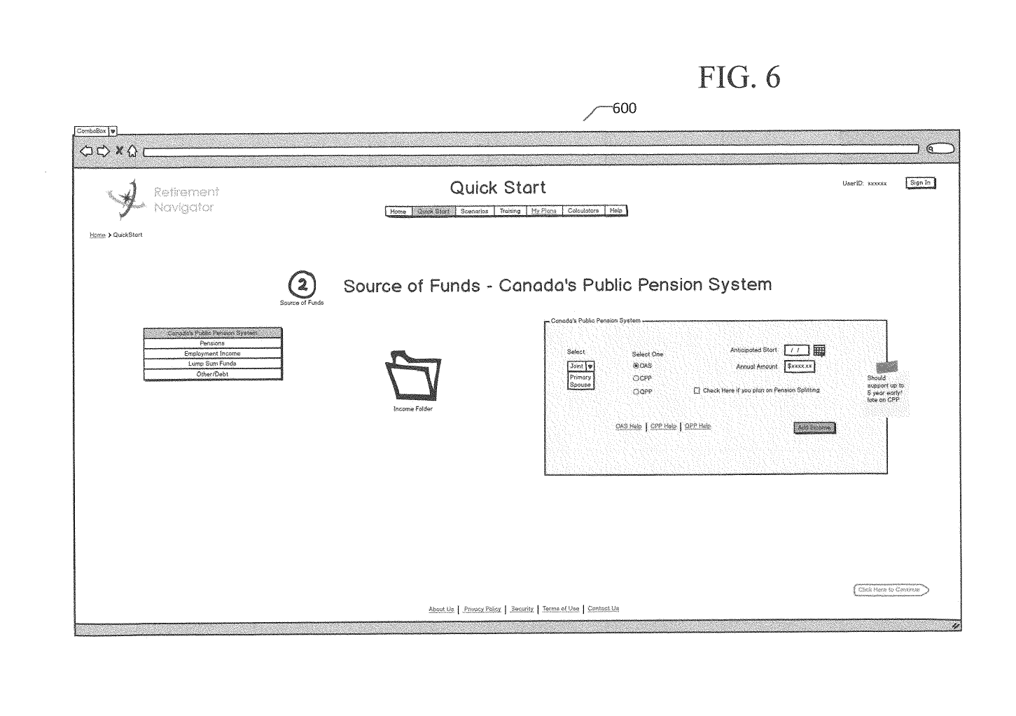

FIG. 6, in screen 600, allows retirees to enter sources of funds or revenue streams, and allows multiple characteristics thereof to be specified so that the revenue streams forming part of the solution are accurate.

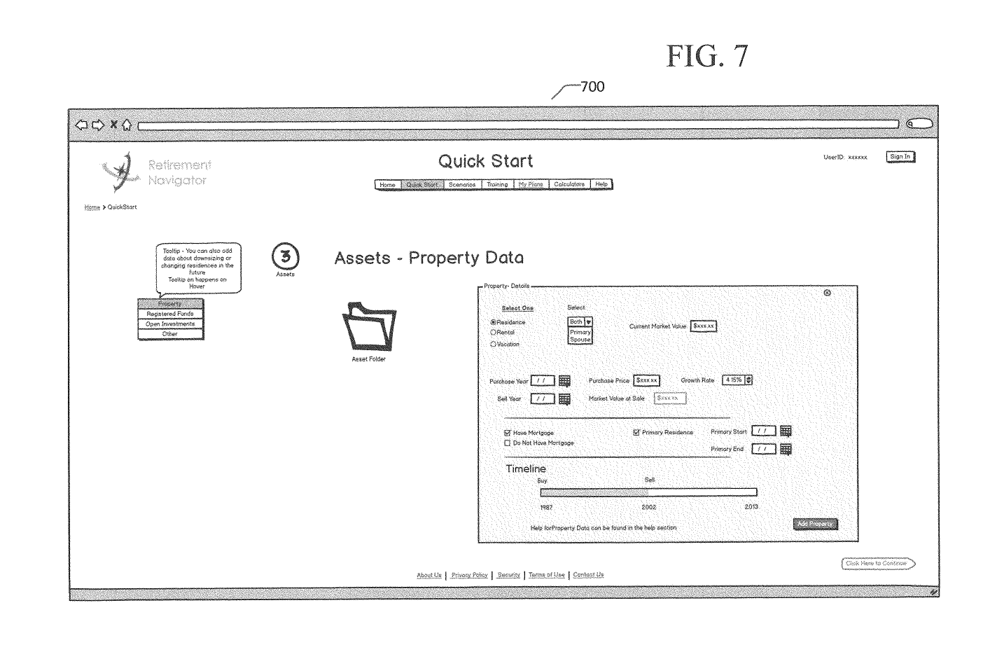

FIG. 7, in screen 700, allows retirees to enter assets that they have, and allows multiple characteristics thereof to be specified so that the revenue streams forming part of the solution are accurate (ie a house having a particular approximate value, with a particular mortgage left). As shown in FIGS. 6 and 7, revenue streams may be streams that are from non-asset sources (such as pensions) whereas assets may include assets that will become revenue streams (typically variable revenue streams) like TFSA accounts, and the like. The division between assets and revenue streams, especially when entering data, is dynamic and need not be thought of as being rigid.

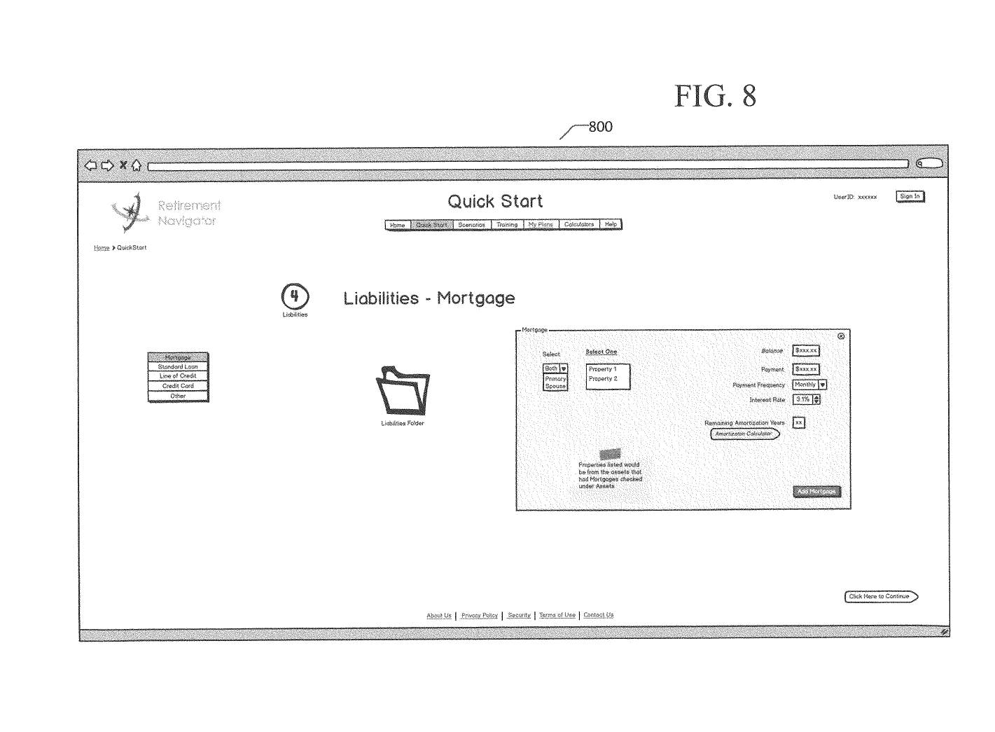

FIG. 8, in screen 800, allows retirees to enter liabilities they have, and allows multiple characteristics thereof to be specified so that the liabilities forming part of the revenue sinks are accurate.

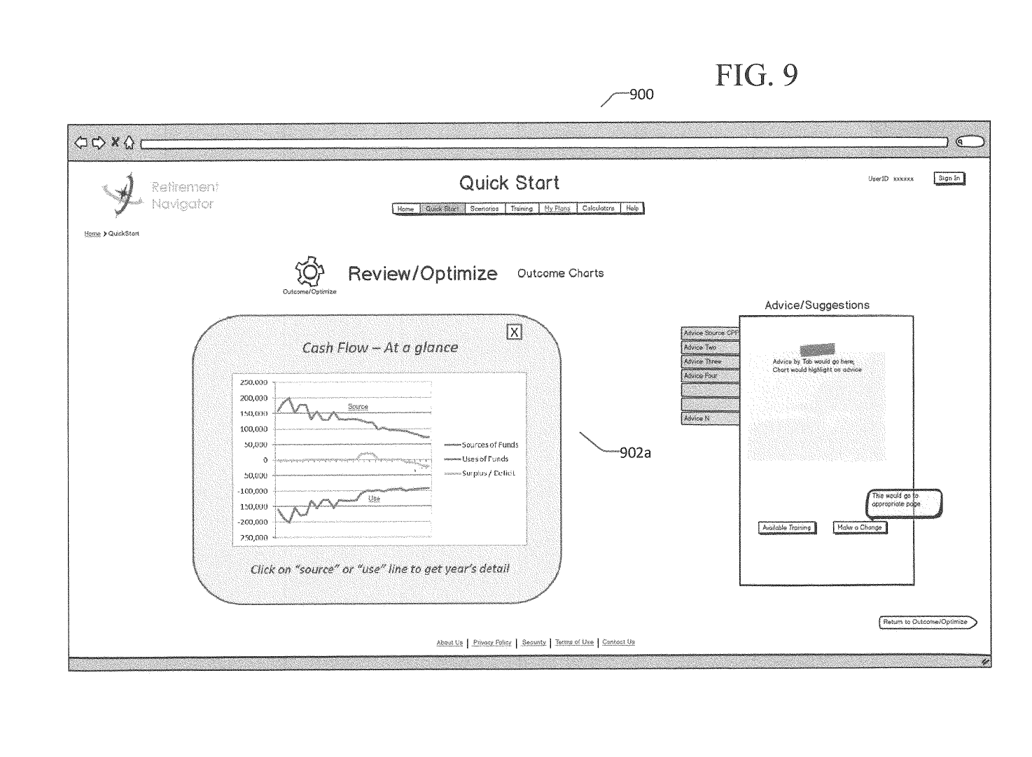

FIG. 9, in screen 900, allows retirees to review and optimize one or more solutions or plans for handling cash flows.

Such review may be accomplished using one or more solution presentment display 902, which may configurably present aspects of one or more solutions. For example, in 902a, a chart is presented showing sources of funds (revenue sources), uses of funds (revenue sinks) and a surplus/deficit line, for each year along the solution. As can be seen in 902a, this presents a viewer (such as a retiree or financial planning professional) the ability to see how funds are used, what funds are available, and importantly, whether adequate revenue sources exist, per year, to cover revenue sinks. In particular the deficit/surplus line (which generally is around 0, indicating there is a balance between sources and sinks) can be used as a quick gauge to determine how good the solution is (ie the greater the deviation from zero, the worse, or the greater the sum of the area below the zero line, the worse, etc).

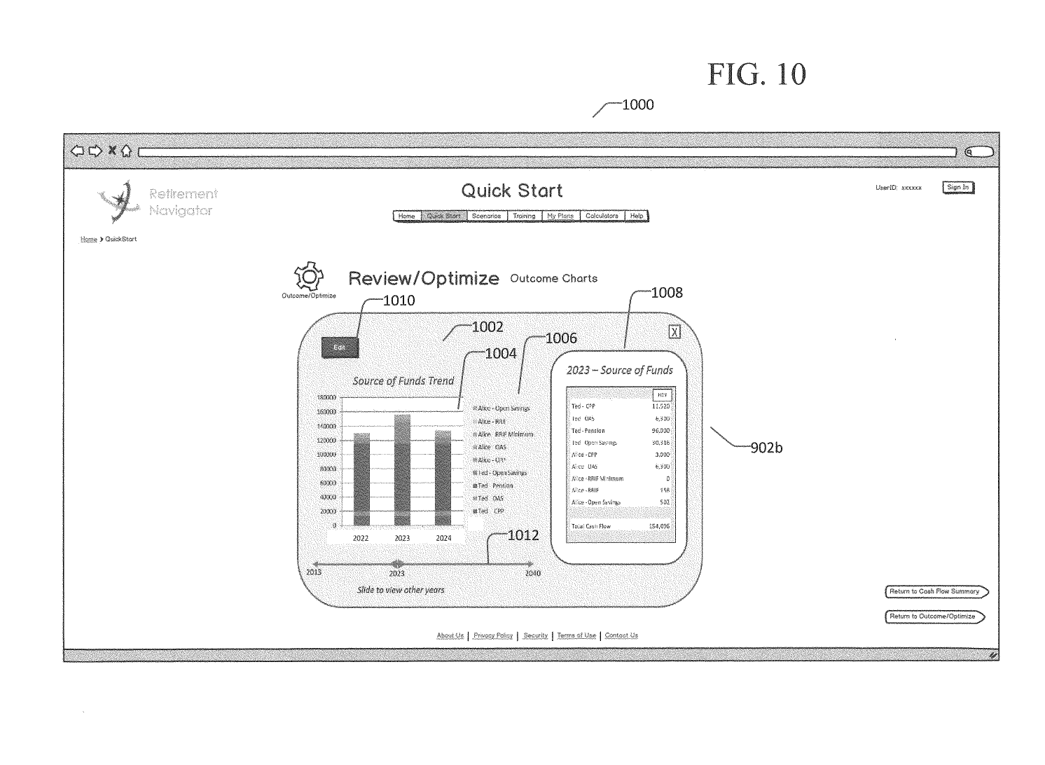

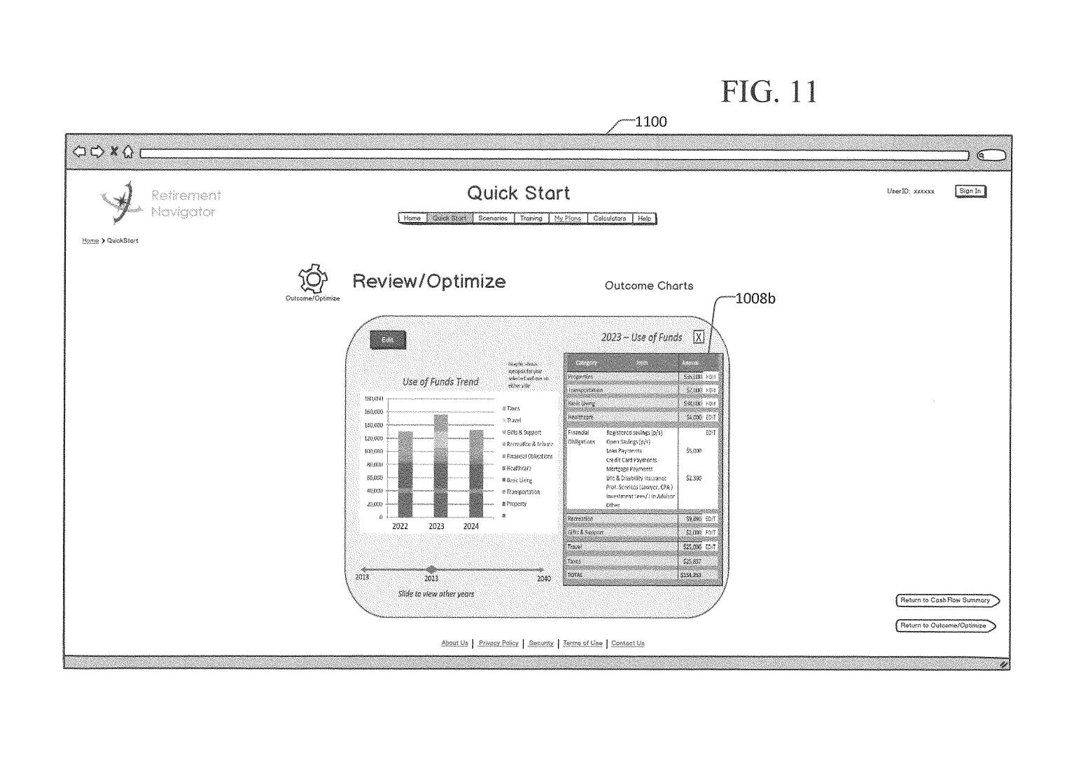

FIG. 10, in screen 1000, presents an alternative solution presentment display 902b, which further comprises a bar graph 1002 that shows or displays a bar graph of the sources of funds contributions to the funds used for a given year (and each source's amounts contributed), with a legend 1006 that clarifies which portion of the bar chart represents revenue from which revenue source. Scroll 1012 allows each year of a particular solution to be viewed. This may present a retiree or financial planning professional a quick way to see what revenue sources are contributing what amount of revenue for each year—quickly assessing any obvious problems with such contributions. Also shown, in detailed data area 1008, are the sources of funds for the year selected (2023), showing the underlying data. Edit button 1010 allows various parameters of the data shown to be modified, such as in FIG. 11, in screen 1100, where uses of funds are shown in detailed data area 1010b and may be edited (in the case shown, to amend the desired uses of data, for a revised solution to then be calculated).

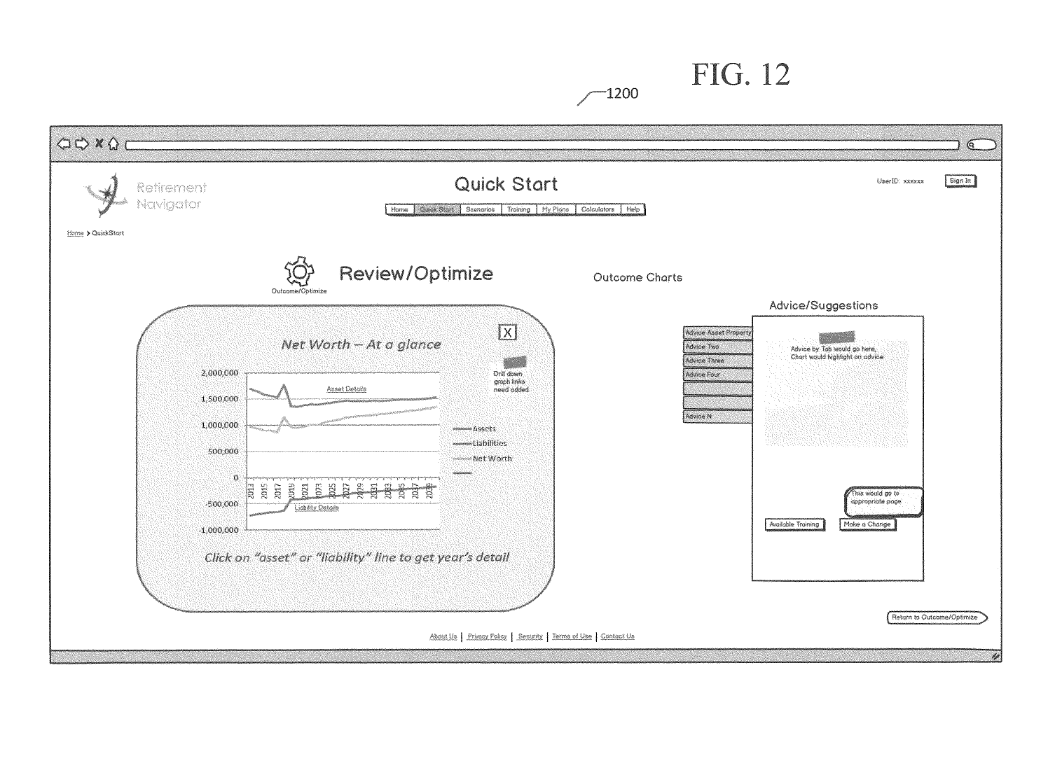

FIG. 12, in screen 1200, allows users to quickly review their net worth over the years of the solution.

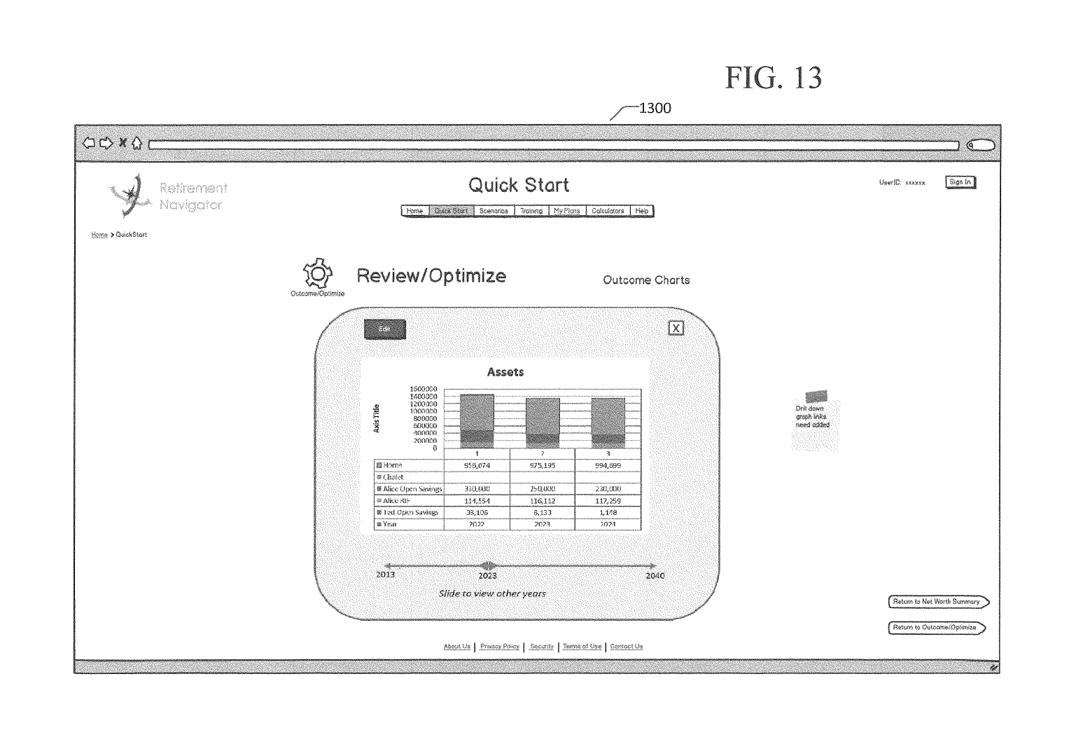

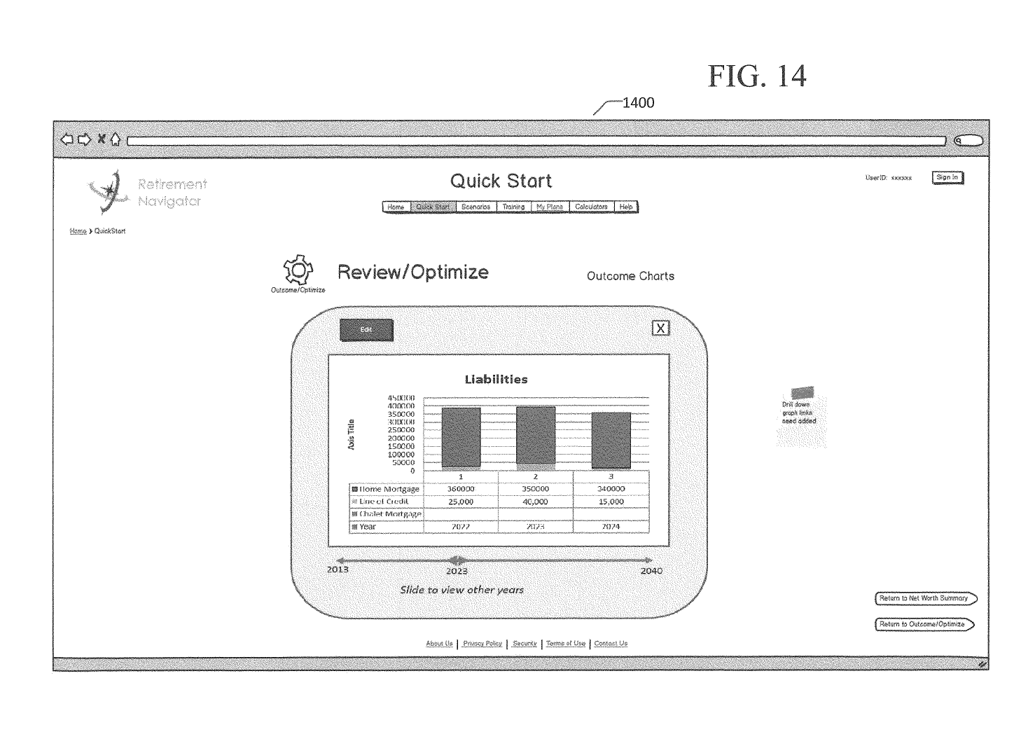

FIGS. 13 and 14, in screens 1300 and 1400, allow users to view further information about their net worth in a given year, including the state of their assets, liabilities, cash flow sources and sinks, and the like. Having this ability to drill into the underlying data may assist various users in pinpointing issues that need further review and that may be causing cash flow solutions to be, for example, overly optimistic or overly pessimistic.

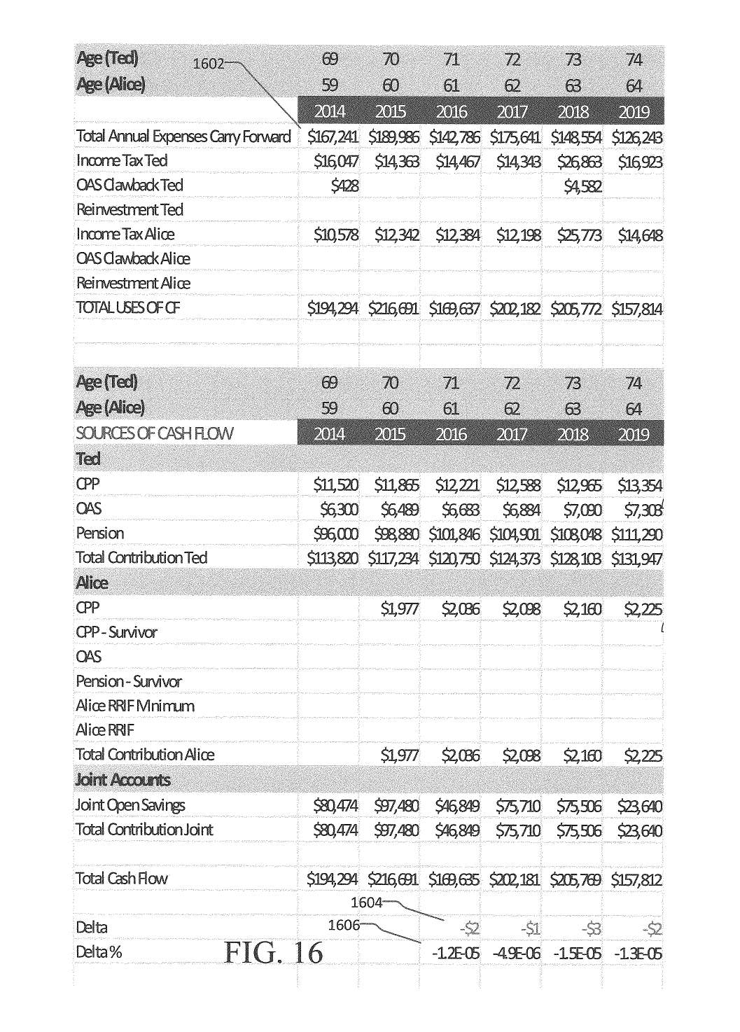

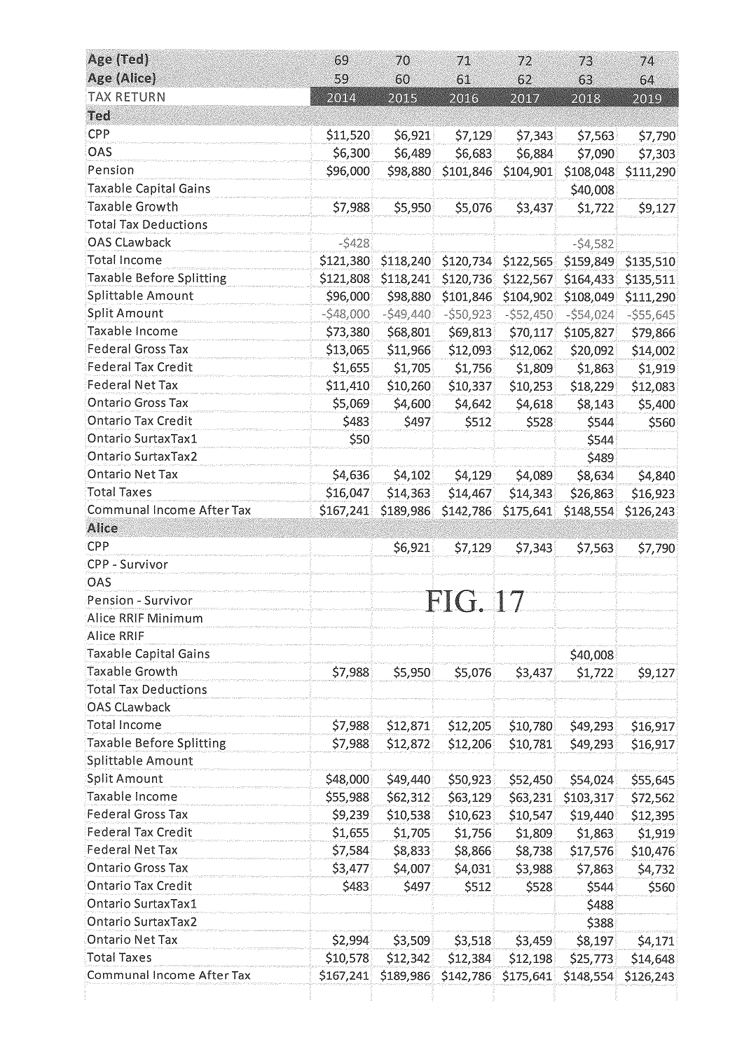

Having described various aspects of embodiments of the systems and methods of the invention, a brief example will now be described, as described herein and with reference to FIGS. 16-18.

In the present example, the data in the “Sample XML File”, below, was input to create an XML file to use to obtain one or more solutions for a user.

In this sample there are two spouses, Ted and Alice that require financial planning. In the input XML we have a plan start date (2014), end date (2040) (noting that only years 2014-2019 of the cash flow solution are shown in FIGS. 16-18), some constants like CPP, OAS start age and so on. The input XML contains a primary person and a spouse person (optional). It also may contain a list of financial instruments (finstrumentList) Financial instruments can be fixed income type, like CPP and OAS, for which the amount of money coming in is fixed and cannot be changed by the engine. Also they can be variable, like a savings account fund, RRIF or TFSA. The engine will determine the amount of money to be withdrawn from each of these variable financial instruments each year for each person.

The input XML file also contains information about required amount for each year. These amounts are the combined net amount of all expenses for the family. For example in year 2014 we specified that the couple needs to spend $167241 (see 1602 in the cash flow solution).

This input comes from the user and includes all kinds of expenses: mortgage, rent, vacations, etc.

At the end of the input file we have events. These are financial events that happen during the planning window. For example we specified that a property (the Chalet) will be sold in 2018 and the proceeds of the sale will go the joint savings account (see 1802 in the cash flow solution), defined in the financial list section above.

Calculation

The engine takes the XML input files, does some pre-processing for adjusting some values, for example it will adjust the CPP and OAS entitlements based on the year a person decides to start receiving the benefits, because the CPP amount is different if a person decides to start receiving CPP or OAS earlier than 65 or later that 65 (in Ontario, the jurisdiction in question for the current example). Mortgage schedules together with some other values are also calculated in this phase.

After the pre-processing is done, the engine calculates all possible combination of variable funds that could be used to make up the required amount for each year.

Let us analyze the year 2014.

The required amount for this year is $167241.

Ted receives CPP—$11520, OAS—$6300, Pension—$96000

Alice does not have any fixed income this year. The engine has the option to use their Joint Savings Account and Alice's RRIF account to make up for the difference needed to satisfy the required amount for this year. When processing is started, there are multiple combinations of funds available to the engine to make up the difference by using those two variable funds:

1) 0% Savings—100% RRIF

2) 25% Savings—75% RRIF

3) 50% Savings—50% RRIF

4) and so on (or, of course, increments could change, etc, as described herein).

In this particular solution, the engine picked 100% Savings (see 1806 in the cash flow solution) and 0% RRIF, (see 1804 in the cash flow solution) basically taking all the difference from savings to make up the amount needed.

The output of the engine is displayed in FIGS. 16-18. Funds were withdrawn from the Savings account at 1806. The “Delta”, at 1604 is the difference between the required amount and the actual amount (which may be net and/or after taxes). The target is to keep the delta percentage (see 1606) within 1.5% of the required amount. In the present example the couple (retirees) ran out of money in year 2040 when the delta is bigger than 1.5% of the required amount (though this cannot be seen as the part of the solution shown in FIGS. 16-18 does not include 2040).

Each year can have a different combination of funds so in one year the engine decides to take all the money from Savings while in another will take half from Savings and the other half from RRIF.

The engine also does a full tax calculation including OAS claw-back. All the information is displayed in the cash flow solution.

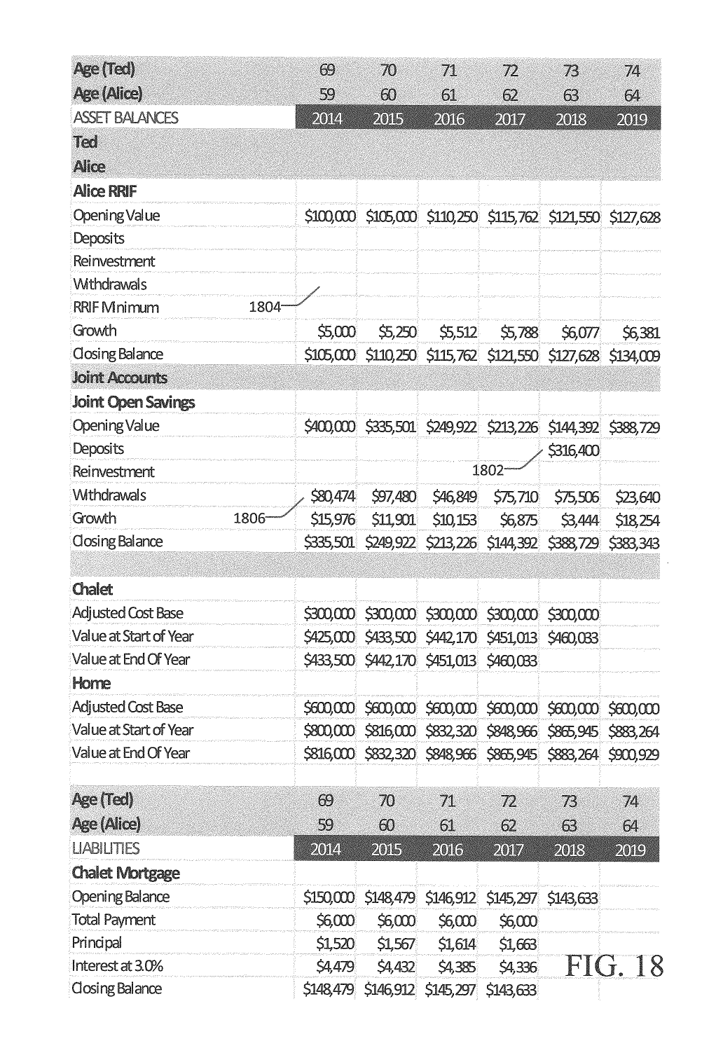

A balance for each of the variable funds is printed in the ASSET BALANCES in FIG. 18.

Of course there exist variations on some of the technical approaches described herein that are intended to be part of embodiments of the invention. For instance, many heuristics and meta-heuristics may be employed. Increased computational power may be used, including parallel processing, and the like. Apportionment strategies may differ—for example they may comprise splitting cash flow requirements into absolute dollar amounts, as opposed to percentages.

There are also many variations to the user interface and method of presenting/collecting inputs and cash flow solutions; those shown are intended to be merely exemplary.

This concludes the description of the presently preferred embodiments of the invention. The foregoing description has been presented for the purpose of illustration and is not intended to be exhaustive or to limit the invention to the precise form disclosed. It is intended the scope of the invention be limited not by this description but by the claims that follow.

1. A method for selecting, computing and scoring optimal or best cash flow solutions for a user having an estimated lifespan, the user having a set of money streams comprising fixed money streams, savings streams and asset depletion money streams, and a set of money sinks that vary each year for the user's life, cash flow solutions including how much money is to be used from each money stream for each year to attempt to meet the total money sinks for each year in a best or optimal way, the method comprising
obtaining, for the user, the money sources and money sinks for each year of the user's lifespan;
setting one or more configuration parameters;
determining a set of possible cash flow solutions based on the configuration parameters; and
until an end trigger is received:
selecting from the set of possible cash flow solutions, a possible cash flow solution;
scoring the possible cash flow solution to determine a score;
if the possible cash flow solution has a score that is better than a best score then:
saving the possible cash flow solution as the best cash flow solution, with the score as the best score.

2. The method of claim 1 wherein the configuration parameters comprise an apportionment strategy.

3. The method of claim 2 wherein the apportionment strategy is assigning each money stream a percentage of the money sink for each year of the lifespan.

4. The method of claim 3 wherein the configuration parameters further comprise a percentage increment such that in assigning each money stream a percentage the percentage is incremented or decremented by the percentage increment in the determining.

5. The method of claim 1 wherein the configuration parameters comprise one or more heuristics or metaheuristics and a computing time, wherein the max computing time is an end trigger.

6. The method of claim 5 wherein the selecting is based on the one or more heuristics or metaheuristics.

7. The method of claim 1 where the configuration parameters comprise one or more hard constraints and one or more soft constraints.

8. The method of claim 7 wherein the scoring further comprises:
specifying whether the best cash flow solution may break any of the one or more hard constraints.

9. The method of claim 8 wherein the scoring further comprises:
for each year of the lifespan:
querying whether a difference between a sum of the revenue streams for the year and the sum of the revenue sinks for the year is within a tolerable range; and
if so then assigning a yearly score of zero for the year, otherwise setting the yearly score for the year to be the difference between the sum of the revenue streams for the year minus the sum of the revenue sinks for the year; and
summing each yearly score to determine the score.

10. The method of claim 9 wherein the scoring further comprises determining one or more soft scores for the cash flow solution and if the score and the best score are similar then comparing one or more soft scores to determine whether the score is the best score.

11. A system for selecting, computing and scoring optimal or best cash flow solutions for a user having an estimated lifespan, the user having a set of money streams comprising fixed money streams, savings streams and asset depletion money streams, and a set of money sinks that vary each year for the user's life, cash flow solutions including how much money is to be used from each money stream for each year to attempt to meet the total money sinks for each year in a best or optimal way, the system comprising:
a web application configured to:
obtain, for the user, the money sources and money sinks for each year of the user's lifespan;
a configuration engine configured to:
set one or more configuration parameters;
a combination generator, configured to:
determine a set of possible cash flow solutions based on the configuration parameters; and
a scoring engine configured to:
until an end trigger is received:
selecting from the set of possible cash flow solutions, a possible cash flow solution;
scoring the possible cash flow solution to determine a score;
if the possible cash flow solution has a score that is better than a best score then:
saving the possible cash flow solution as the best cash flow solution, with the score as the best score.

12. The system of claim 11 wherein the configuration parameters comprise an apportionment strategy.

13. The system of claim 12 wherein the apportionment strategy is assigning each money stream a percentage of the money sink for each year of the lifespan.

14. The system of claim 13 wherein the configuration parameters further comprise a percentage increment such that in assigning each money stream a percentage the percentage is incremented or decremented by the percentage increment in the determining.

15. The system of claim 11 wherein the configuration parameters comprise one or more heuristics or metaheuristics and a computing time, wherein the max computing time is an end trigger.

16. The system of claim 15 wherein the selecting is based on the one or more heuristics or metaheuristics.

17. The system of claim 11 where the configuration parameters comprise one or more hard constraints and one or more soft constraints.

18. The system of claim 17 wherein the scoring further comprises:
specifying whether the best cash flow solution may break any of the one or more hard constraints.

19. The system of claim 18 wherein the scoring further comprises:
for each year of the lifespan:
querying whether a difference between a sum of the revenue streams for the year and the sum of the revenue sinks for the year is within a tolerable range; and
if so then assigning a yearly score of zero for the year, otherwise setting the yearly score for the year to be the difference between the sum of the revenue streams for the year minus the sum of the revenue sinks for the year; and
summing each yearly score to determine the score.

20. The system of claim 19 wherein the scoring further comprises determining one or more soft scores for the cash flow solution and if the score and the best score are similar then comparing one or more soft scores to determine whether the score is the best score.
